(19) United States
(12) Patent Application Publication
(10) Pub. No.: US 2008/0026140 A1
(43) Pub. Date: Jan. 31, 2008

(54) GRAFFITI FURNITURE

(76) Inventors: E. Bradley Clark, Lancaster, PA (US); Douglas Homer, Exton, PA (US)

Correspondence Address: MCNEES WALLACE & NURICK LLC, 100 PINE STREET, P.O. BOX 1166, HARRISBURG, PA, 17108-1166, US

(21) Appl. No.: 11/459,679

(22) Filed: Jul. 25, 2006

(51) Int. Cl. B32B 43/00

(52) U.S. Cl. 427/140; 156/98

(57) ABSTRACT

A method for surface treating antique or reproduction furniture including providing an antique or reproduction of an antique article of furniture having a surface for receiving a visual element. The method further includes coating the surface of the article with a pigment-carrying device in a manner that provides the article with the appearance that the surface of the article has been subject to graffiti. The coating step includes providing elements on the surface selected from the group consisting of random strokes, identifying words, identifying images, cartoon art, and combinations thereof.

### FIELD OF THE INVENTION

The present invention is directed to methods for surface treating antique furniture and reproduction antique furniture.

### BACKGROUND OF THE INVENTION

Antique furniture is desirable to collectors and others who value the furniture for its beauty, craftsmanship and rarity. However, many times antique furniture has an undesirable surface finish, damage is present on the surface of the furniture, or the style of furniture is unsuitable for a contemporary decorating scheme. Matching pieces, masking damage and/or restoring the original finish is expensive and time consuming. In addition, the original surface treatment, typically stain, is many times undesirable for a contemporary decorating scheme.

Particular types of furniture, such as highboy, also commonly referred to as Tallboys, are particularly desirable because they provide a high quality level of craftsmanship and desirable features. Antique highboys, preferably those manufactured during the 18th Century, are likely sought. Reproductions of highboys replicating the 18^{th} Century style of the furniture may also have excellent value. Highboys provide a large amount of storage while occupying a relatively small amount of floor space. The small amount of floor space makes the style of furniture particularly desirable for small apartments or smaller rooms. The wood utilized, particularly in authentic antique highboys, may include hardwood, such as mahogany or walnut, and are particularly desirable for the longevity, texture and appearance. However, this style of furniture suffers from the drawback that the original surface finish may be out of place or not match other pieces of furniture in a contemporary home or apartment.

Therefore, what is needed is a surface treatment for antique furniture that provides the surface with a contemporary appearance differing or contrasting that of the manufacturing date of the furniture. Further, what is needed is a surface treatment that allows the masking of damage or replacement of portion(s) of the furniture without the need to perform a complete restoration of the piece of furniture.

### SUMMARY OF THE INVENTION

The present invention includes a method for surface treating antique or reproduction furniture, including providing an antique or reproduction of an antique article of furniture having a surface for receiving a visual element. The method further includes coating the surface of the article with a pigment-carrying device in a manner that provides the article with the appearance that the surface of the article has been subject to graffiti. The coating step includes providing elements on the surface selected from the group consisting of random strokes, identifying words, identifying images, cartoon art, and combinations thereof.

The present invention also includes a method for refurbishing or recycling antique or reproduction furniture. The method includes providing an antique or reproduction of an antique article of furniture having a surface in which the original surface treatment is defective. The method further includes coating the surface of the article with a pigment-carrying device in a manner that covers defects in the original surface treatment and provides the article with the appearance that the surface of the article has been subject to graffiti. The coating step also includes providing elements on the surface selected from the group consisting of random strokes, identifying words, identifying images, cartoon art, and combinations thereof. The coating is applied in a manner that reduces, eliminates or incorporates the appearance of defects in the original surface treatment.

The present invention has the advantage that the surface treatment may be easily applied with readily available tools, such as brushes and/or spray cans.

Another advantage of the present invention is that the furniture may include defects that previously would have rendered the furniture undesirable.

Another advantage of the present invention is that the elements may be customizable, permitting the elements to include desirable personalized elements.

Another advantage of the present invention is that the surface treatment of the present invention allows antique or reproduction antique furniture to be utilized in contemporary decorating.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 shows a piece of furniture for use with the process of the present invention.

FIG. 2 shows the furniture of FIG. 1 subject to the process of the present invention.

FIG. 3 shows an alternate embodiment of the furniture of FIG. 1 subject to the process of the present invention.

FIG. 4 shows a damaged piece of furniture for use with the process of the present invention.

FIG. 5 shows an embodiment of the furniture of FIG. 4 subject to the process of the present invention.

FIG. 6 is a photograph of a highboy according to an embodiment of the invention.

Wherever possible, the same reference numbers will be used throughout the drawings to refer to the same or like parts.

### DETAILED DESCRIPTION OF THE INVENTION

The present invention includes a method for refurbishing furniture, including providing an antique or reproduction piece of furniture and surface treating the surface of the furniture with paint or other pigment-carrying device or material removal device with or without a pigment carrying device. The surface treatment provides a series of deliberately inscribed markings made by hand or having the appearance of being made by hand, such as art drawings or works having the appearance of urban/modern graffiti.

The method of the present invention is applied to antique furniture to refurbish or recycle the antique furniture. The antique or reproduction piece of furniture subjected to the method of the present invention includes a piece of furniture that was created in a predetermined design period or mimics the furniture of a predetermined design period. The surface treatment permits damage to be covered or hidden, allowing the underlying piece to have imperfections that would typically reduce the value of the furniture. The imperfections may also be incorporated into the surface treatment to provide an aesthetically pleasing element. The furniture preferably has sufficient continuous surface space to be viewable by an observer after the surface treatment has been applied. One embodiment of the present invention includes providing an antique or reproduction highboy having a large continuous surface for viewing the surface treatment.

The step of applying a surface treatment includes an automated application method or manual application of the paint or pigment-carrying device in a manner that simulates urban/modern graffiti. In a preferred embodiment, the surface treatment is applied manually and each surface treatment is substantially unique. The surface treatment may be applied in a predetermined pattern or in a substantially random pattern.

In an alternate embodiment of the invention, the surface treatment may be provided in a predetermined pattern that allows indicia, such as identifying words, and/or identifying pictures. The indicia permits customization of a particular piece of furniture that allows the surface treatment that may be tailored to the particular end user of the furniture. For example, the name, initials, or likeness may be incorporated into the surface treatment.

The surface treatment preferably provides indicia of a particular time period or theme, wherein the time-period is different than the time period in which the furniture was manufactured or appears to be manufactured. For example, the surface treatment may include stylized words, drawings or art identifiable with a particular time, decade or era or may be identified with a theme that contrasts a theme that would be present at the time of manufacture for the antique furniture (e.g., a theme element on an antique highboy unknown or inappropriate in the 17^{th} Century). The time, decade or era depicted by the surface treatment is substantially different than the time in which the antique furniture was manufactured or the time of manufacture of the furniture in which the reproduction is reproducing. The depiction of the time-reference or theme in the surface treatment is provided by one or more visual elements. The visual elements make up or are incorporated by the graffiti surface treatment. The elements may be any visually perceptible indicator that provides the viewer with the ability to identify a time, decade, era or theme depicted by the surface treatment. Suitable elements include, but are not limited to, tags, such as individual or gang-identified tags, caricatures of celebrities or well-known persons, cartoon depictions, such as of a landscape or cityscape, indicia such as names, nicknames, initials or likenesses of a person or persons.

For example, tags indicative of gangs, geographic locations or particular artists may be provided to the furniture, wherein the furniture is an authentic antique or reproduction of a mid-18^{th} century highboy. In addition, a surface treatment may portray a caricature of a celebrity or well-known person of a particular time, decade, era or theme. The surface treatment may depict a cityscape or street scene of a particular time, decade, era or theme.

The method of application of the surface treatment may be any suitable application method that provides the appearance of graffiti. For example, the application may be spraying, brushing, and/or dip coating. In a preferred embodiment, the surface treatment is applied by hand, either by spraying or brushing.

In another embodiment of the invention, the surface treatment may also include removing a portion of the surface to provide the visual elements. The removal of the surface is performed in a similar manner as the surface treatment application, with the surface being removed as opposed to coated. Removal methods may include sand blasting, peening or other methods that remove material from the furniture or in combination with an application method. The removal methods may be used in place of the application methods or in addition to the application methods.

In addition to the surface treatment, where the visual elements are provided, the surface treatment may also include lacquer or clear coatings to provide additional protection for the surface treatment. The application of the clear coating allows the surface treatment to have the appearance of graffiti, but provides the surface protection of a lacquer, stain, clear coat or paint necessary to provide a piece of furniture with adequate protection for everyday use.

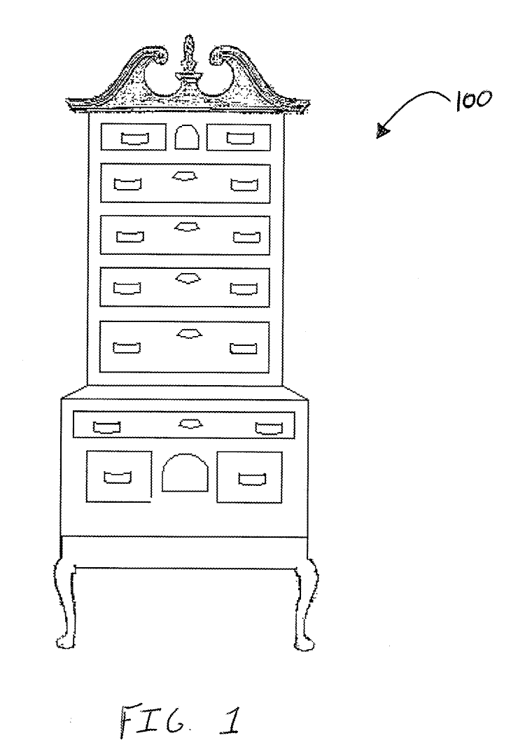

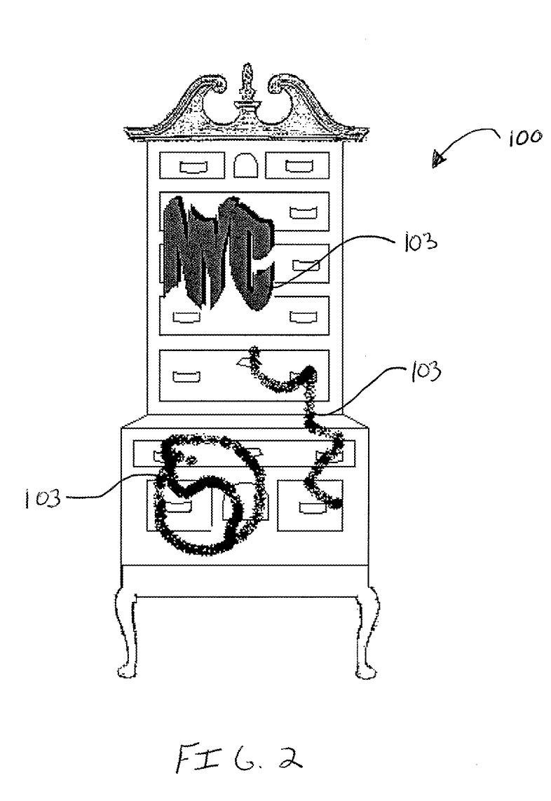

FIG. 1 shows a highboy 100 suitable for use with the process of the present invention. Although FIG. 1 depicts a highboy piece of furniture, other pieces of antique or reproduction furniture may be used, provided that the furniture is indicative of a time of manufacture that is substantially different than the time represented by a visual element 103 (see FIG. 2).

FIG. 2 shows the highboy 100 of FIG. 1 subject to the process of the present invention. The highboy 100 includes the surface treatment as having visual elements 103, which provide identification of a geographic location, a tag identifier and/or artwork indicative of a theme.

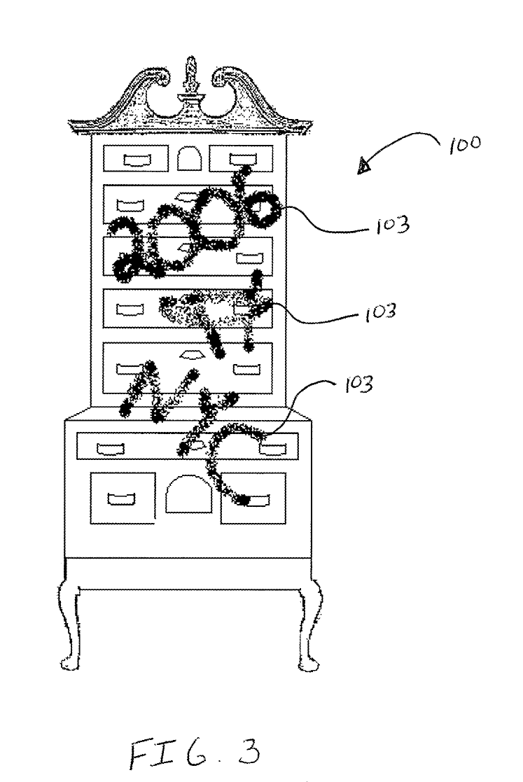

FIG. 3 shows an alternate embodiment of the present invention on the highboy 100 of FIG. 1, wherein the visual elements include a time, a tag identifier and/or geographic location. As shown in FIGS. 2-3, the visual elements 103 present on the surface of the furniture need not represent a single time, decade, era or theme and may incorporate several visual elements 103 of differing times, decades, eras or themes. The surface of the furniture underlying visual elements 103 may be partially or fully covered with paint or other pigment. Alternatively, portions of the surface may be intentionally abraded or removed to exposed the underlying wood or material used to construct the furniture. In addition, the visual elements 103 may be formed from the areas of removed surface. In another embodiment of the invention, the original finish of the furniture is permitted to remain underneath the visual elements 103.

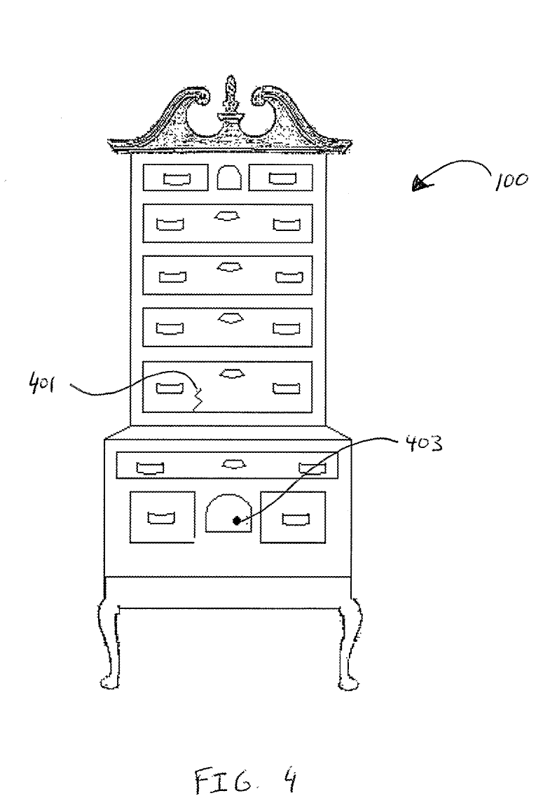

FIG. 4 shows a damaged highboy 100 suitable for use with the present invention. As shown, a damaged highboy 100 is provided with a crack 401 and a hole 403. While the damage depicted in FIG. 4 has been described as a crack 401 and a hole 403, other types of damage, such as scratches, broken components, broken decorative elements, missing or broken hardware or other damage visible on an untreated piece of furniture.

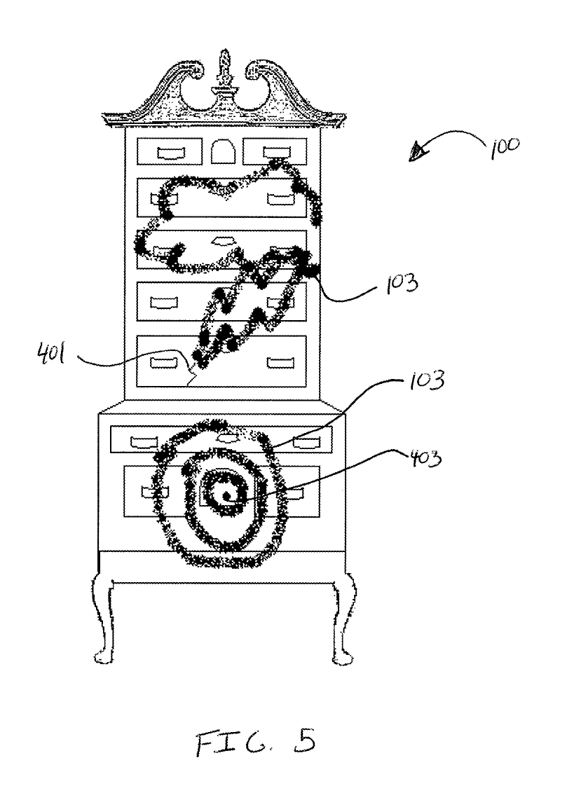

FIG. 5 shows the damaged highboy 100 subjected to the process of the present invention, wherein themed visual elements 103 incorporate the damage to mask the damage or transform the appearance of the damage to be aesthetically pleasing. With the process of the present invention, replacement parts, such as replacement drawers, may be provided that do not precisely match the original surface finish, but may be incorporated into or masked by the visual elements 103. In addition, furniture partially or fully covered with paint or other pigment underlying the visual elements 103 may provide masking of damage, while providing a background surface to emphasize the visual elements 103.

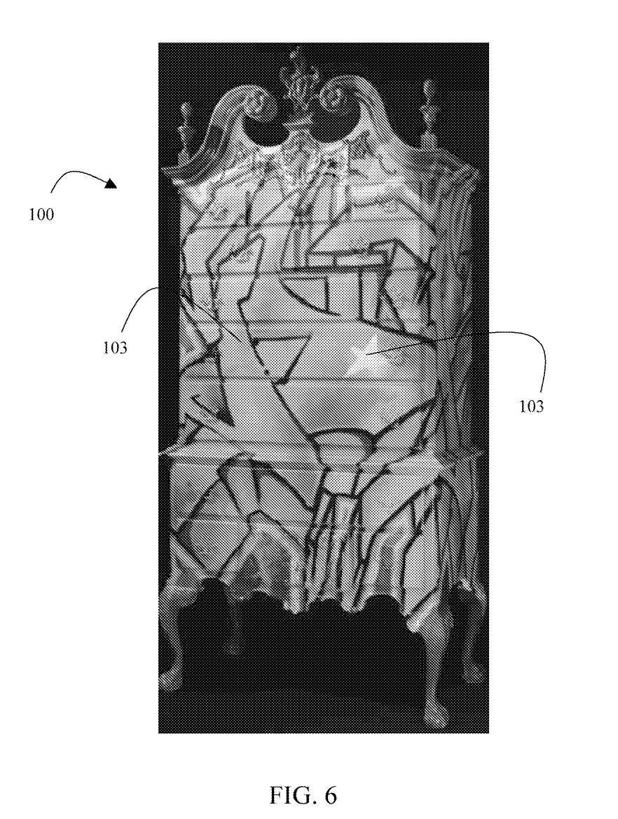

FIG. 6 shows a photograph of a highboy 100 according to an embodiment of the invention. As shown, the highboy 100 includes visual elements 103, including tags and cartoon images having indicia of a particular time period or theme, wherein the time-period is different than the time period in which the furniture was manufactured or appears to be manufactured.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A method for surface treating antique or reproduction furniture comprising:
providing an article of furniture having a surface, the article being an antique or reproduction of an antique;
coating the surface of the article with a pigment-carrying device in manner that provides the article with the appearance that the surface of the article has been subject to graffiti, and
wherein the coating step includes providing elements on the surface selected from the group consisting of random strokes, identifying words, identifying images, cartoon art, and combinations thereof.

2. The method of claim 1, wherein the step of coating includes an application method selected from the group consisting of spraying, brushing, and dipping.

3. The method of claim 1, wherein the step of coating includes spraying the pigment-carrying device onto the surface.

4. The method of claim 1, wherein the step of coating includes brushing the pigment-carrying device onto the surface by hand.

5. The method of claim 1, further comprising removing material from a portion of the surface.

6. The method of claim 1, wherein the removal is by sand blasting, or peening the surface.

7. The method of claim 1, wherein the article is a highboy.

8. The method of claim 1, further comprising applying a protective transparent overcoat to the surface treated article.

9. The method of claim 1, wherein the element includes a tag.

10. The method of claim 1, wherein the element includes a caricature of a celebrity or well-known person.

11. The method of claim 1, wherein the element includes a cartoon depiction of a landscape or cityscape.

12. The method of claim 1, wherein the element includes indicia selected from the group consisting of a name, nickname, initials or likeness of a person.

13. A method for refurbishing or recycling antique or reproduction furniture comprising:
providing an article of furniture having a surface in which at least a portion of the original surface treatment is defective, the article being an antique or reproduction of an antique;
coating the surface of the article with a pigment-carrying device in a manner that covers defects in the original surface treatment and provides the article with the appearance that the surface of the article has been subject to graffiti,
wherein the coating step includes providing elements on the surface selected from the group consisting of random strokes, identifying words, identifying images, cartoon art, and combinations thereof, and
wherein the coating is applied in a manner that reduces, eliminates or incorporates the appearance of defects in the original surface treatment.

14. The method of claim 13, wherein the original surface treatment has paint that is chipped or scratched.

15. The method of claim 13, wherein the original surface treatment includes cracks, holes or scratches in the surface of the article.

16. The method of claim 15, wherein the elements incorporate the cracks, holes or scratches.

17. The method of claim 13, further comprising providing a component configured to replace a defective portion of the article, the component being coated in the same manner as the article, and wherein the component is exchanged for the defective portion.

18. The method of claim 17, the component is selected from the group consisting of a drawer, hardware, and decorative element.

19. The method of claim 13, wherein the element includes a tag.

20. The method of claim 1, wherein the element includes indicia selected from the group consisting of a name, nickname, initials or likeness of a person.
